(19) United States
(12) Patent Application Publication
(10) Pub. No.: US 2018/0248658 A1
(43) Pub. Date: Aug. 30, 2018

(54) TRANSMITTING DOWNLINK SIGNALS

(71) Applicant: TELEFONAKTIEBOLAGET LM ERICSSON (PUBL), Stockholm (SE)

(72) Inventors: Marco BELLESCHI, Solna (SE); Gunnar BERGQUIST, Kista (SE); Christer GUSTAFSSON, Huddinge (SE); Anders OHLSSON, Järfälla (SE); Hongwei WANG, Solna (SE)

(21) Appl. No.: 15/753,512

(22) PCT Filed: Aug. 28, 2015
(86) PCT No.: PCT/SE2015/050909

§ 371 Date: Feb. 19, 2018

(51) Int. Cl. H04L 1/18; H04W 24/08; H04B 17/309

(52) U.S. Cl. CPC H04L 1/1809; H04L 1/1874; H04W 84/042; H04W 24/08; H04B 17/309; H04L 1/1887

(57) ABSTRACT

It is provided a method for transmitting downlink signals. The method is performed in a network node of a cellular network and comprises the steps of: transmitting a first downlink signal to a wireless device, the first downlink signal comprising a first set of payload data; determining a failed reception of the first downlink signal; determining that a new set of payload data is available in a downlink buffer; combining at least part of the first set of payload data with at least part of the new set of payload data in a combined set of payload data; and transmitting a second downlink signal to the wireless device, the second downlink signal comprising the combined set of payload data.

### TECHNICAL FIELD

The invention relates to a method, a network node, a computer program and a computer program product for transmitting downlink signals, particularly when a first downlink signal fails to be received.

### BACKGROUND

Cellular communication networks evolve towards higher data rates, together with improved capacity and coverage. In the 3rd Generation Partnership Project (3GPP) standardization body, several technologies have been and are also currently being developed.

LTE is a recently standardised technology. It uses an access technology based on OFDM (Orthogonal Frequency Division Multiplexing) for the downlink (DL) and Single Carrier FDMA (SC-FDMA) for the uplink (UL). The resource allocation to wireless devices on both DL and UL is performed adaptively by the concept of fast scheduling, taking into account the instantaneous traffic pattern and radio propagation characteristics of each wireless device. Assigning resources in both DL and UL is performed in the scheduler situated in a network node such as the radio base station.

In order to save power in wireless devices, DRX (Discontinuous Reception) can be used. A DRX cycle consists of a receiving period (also known as on duration) and an idle period (also known as off duration). No data can be received during the energy saving idle period, but only during the receiving period.

If data reception during an on duration fails, it is retransmitted in the next on duration. However, the periodicity of the on durations can be quite long, whereby such retransmissions give knock on effects of delays for subsequent transmissions.

### SUMMARY

It is an object to reduce the ill-effects due to a failed downlink reception, e.g. when DRX is used.

According to a first aspect, it is provided a method for transmitting downlink signals. The method is performed in a network node of a cellular network and comprises the steps of: transmitting a first downlink signal to a wireless device, the first downlink signal comprising a first set of payload data; determining a failed reception of the first downlink signal; determining that a new set of payload data is available in a downlink buffer; combining at least part of the first set of payload data with at least part of the new set of payload data in a combined set of payload data; and transmitting a second downlink signal to the wireless device, the second downlink signal comprising the combined set of payload data.

In other words, the state of the downlink buffer is utilised and the new set of payload data from the buffer is sent along with the first set of payload data, instead of waiting until it is confirmed that the first set of payload data is received. Especially when there is a large delay between transmission, e.g. when using DRX, this method provides a greatly reduced latency when retransmissions are needed.

The method may further comprise the steps of: obtaining a channel indicator indicating channel conditions for transmission to the wireless device; and determining a size for the combined set of payload data based on the channel conditions. In this way, it is avoided that the size of the combined set exceeds what the radio channel can handle.

The step of determining a size for the combined set of payload data may comprise adding a channel deterioration margin to the channel indicator. This prevents any channel deterioration from the time of the channel indicator to cause further problems in transmissions.

The step of determining a failed reception may comprise determining occurrence of a discontinuous transmission, DTX.

The step of determining a failed reception may comprise receiving a non-acknowledgement, indicating a failed reception of the first downlink signal.

The method may further comprise the step of: obtaining a priority indicator indicating a priority for transmissions to the wireless device. In such a case, in the step of combining, a higher priority indicator results in more of the new set of payload data being included in the combined set of data.

The step of combining may comprise segmenting the mentioned payload data in a radio link control, RLC, layer.

The second downlink signal may comprise a new data indicator, NDI, indicating that the second downlink signal comprises new payload data.

The method may be repeated. In such a case, in the step of combining, the first set of payload data is discarded and is omitted from the combined set of payload data when the first set of data has been transmitted a predefined maximum number of times.

According to a second aspect, it is provided a network node for use in a cellular network for transmitting downlink signals. The network node comprises: a processor; and a memory storing instructions that, when executed by the processor, cause the network node to: transmit a first downlink signal to a wireless device, the first downlink signal comprising a first set of payload data; determine a failed reception of the first downlink signal; determine that a new set of payload data is available in a downlink buffer; combine at least part of the first set of payload data with at least part of the new set of payload data in a combined set of payload data; and transmit a second downlink signal to the wireless device, the second downlink signal comprising the combined set of payload data.

The network node may further comprise instructions that, when executed by the processor, cause the network node to: obtain a channel indicator indicating channel conditions for transmission to the wireless device; and determine a size for the combined set of payload data based on the channel conditions.

The instructions to determine a size for the combined set of payload data may comprise instructions that, when executed by the processor, cause the network node to add a channel deterioration margin to the channel indicator.

The instructions to determine a failed reception may comprise instructions that, when executed by the processor, cause the network node to determine occurrence of a discontinuous transmission, DTX.

The instructions to determine a failed reception may comprise instructions that, when executed by the processor, cause the network node to receive a non-acknowledgement, indicating a failed reception of the first downlink signal.

The network node may further comprising instructions that, when executed by the processor, cause the network node to obtain a priority indicator indicating a priority for transmissions to the wireless device. In such a case, the instructions to combine comprise instructions that, when executed by the processor, cause the network node to include more of the new set of payload data when the priority indicator is higher compared to when the priority indicator is lower.

The instructions to combine may comprise instructions that, when executed by the processor, cause the network node to segment the mentioned payload data in a radio link control, RLC, layer.

The second downlink signal may comprises a new data indicator, NDI, indicating that the second downlink signal comprises new payload data.

The instructions may be repeated. In such a case, the instructions to combine comprise instructions that, when executed by the processor, cause the network node to discard the first set of payload data and omit the first set of payload data from the combined set of payload data when the first set of data has been transmitted a predefined maximum number of times.

According to a third aspect, it is provided a network node comprising: means for transmitting a first downlink signal to a wireless device, the first downlink signal comprising a first set of payload data; means for determining a failed reception of the first downlink signal; means for determining that a new set of payload data is available in a downlink buffer; means for combining at least part of the first set of payload data with at least part of the new set of payload data in a combined set of payload data; and means for transmitting a second downlink signal to the wireless device, the second downlink signal comprising the combined set of payload data.

According to a fourth aspect, it is provided a computer program for transmitting downlink signals. The computer program comprises computer program code which, when run on a network node of a cellular network causes the network node to: transmit a first downlink signal to a wireless device, the first downlink signal comprising a first set of payload data; determine a failed reception of the first downlink signal; determine that a new set of payload data is available in a downlink buffer; combine at least part of the first set of payload data with at least part of the new set of payload data in a combined set of payload data; and transmit a second downlink signal to the wireless device, the second downlink signal comprising the combined set of payload data.

According to a fifth aspect, it is provided a computer program product comprising a computer program according to the fourth aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating a cellular network where embodiments presented herein may be applied;

FIG. 2 is a state diagram illustrating various power states for a wireless device of FIG. 1 in a DRX (Discontinuous Reception mode);

FIG. 3 is a schematic diagram illustrating the interworking of RLC (Radio Link Control) and MAC (Media Access) layers;

FIGS. 4A-B are schematic diagrams illustrating the interworking of RLC (Radio Link Control) and MAC (Media Access) layers when a reception fails according to one embodiment;

FIG. 5 is a schematic diagram illustrating signalling between the network node and the wireless device of FIG. 1 according to one embodiment;

FIGS. 6A-B are flow charts illustrating methods performed in the network node of FIG. 1;

FIG. 7 is a schematic diagram illustrating some components of the network node of FIG. 1;

FIG. 8 is a schematic diagram showing functional modules of the network node of FIGS. 1 and 7;

FIG. 9 shows one example of a computer program product comprising computer readable means.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

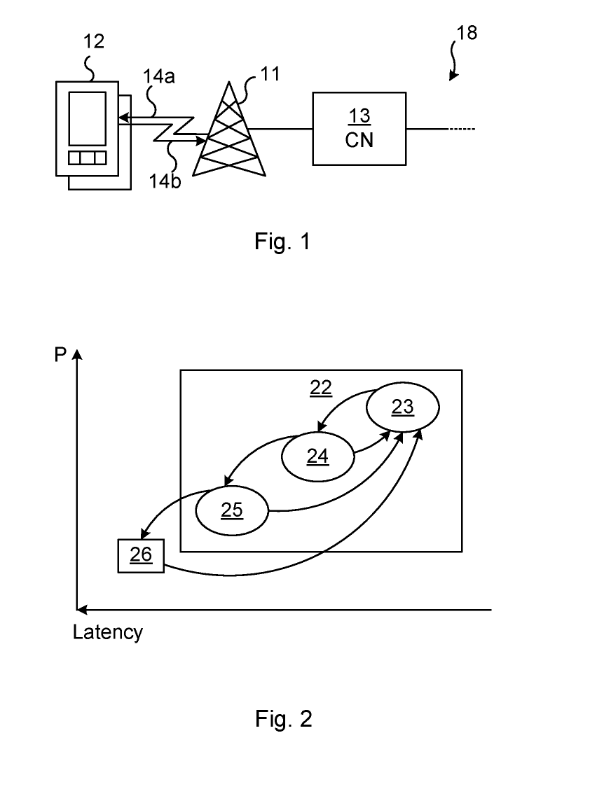

FIG. 1 is a schematic diagram illustrating a cellular network 18 where embodiments presented herein may be applied. The cellular network 18 comprises a core network 13 and one or more network nodes 11, here in the form of radio base stations being evolved Node Bs, also known as eNode Bs or eNBs. The network node 11 could also be in the form of Node Bs, BTSs (Base Transceiver Stations) and/or BSSs (Base Station Subsystems), etc. The network node 11 provides radio connectivity to a plurality of wireless devices 12. The term wireless device is also known as mobile communication terminal, user equipment (UE), mobile terminal, user terminal, user agent, wireless terminal, machine-to-machine devices etc., and can be, for example, what today are commonly known as a mobile phone or a tablet/laptop with wireless connectivity or fixed mounted terminal.

The cellular network 18 may e.g. comply with any one or a combination of LTE (Long Term Evolution), W-CDMA (Wideband Code Division Multiplex), EDGE (Enhanced Data Rates for GSM (Global System for Mobile communication) Evolution), GPRS (General Packet Radio Service), CDMA2000 (Code Division Multiple Access 2000), or any other current or future wireless network, such as LTE-Advanced, as long as the principles described hereinafter are applicable.

Uplink communication (from the wireless device to the network node 11) 14a and downlink communication 14b (from the network node to the wireless device) occur over a wireless radio interface. The quality of the wireless radio interface to each wireless device 12 can vary over time and depends on the position of the wireless device 12, due to effects such as fading, multipath propagation, interference, etc.

The network node 11 is also connected to the core network 13 for connectivity to central functions and a wide area network, such as the Internet.

For handling retransmissions of failed MAC packets, Hybrid Automatic Repeat Request (HARQ) can be used. The HARQ procedure involves providing quick feedbacks in the form of acknowledgements (ACK) or negative acknowledgements (NACK) to the transmitter for each transport block, depending on the result of the decoding applied at the receiver (e.g. using Cyclic Redundancy Check (CRC)). In order to increase the probability of successfully decoding of a transport block, HARQ can be combined with soft combining. In LTE, a soft combining procedure called incremental redundancy can be used. Incremental redundancy implies that the receiver temporarily stores any erroneously received packet and combines it with retransmissions of that packet (retransmitted due to NACK being fed back to the transmitter). Such retransmissions contain the same data as the original transport block but with different encoding thereby puncturing the encoder output in different ways to increase the probability of successful decoding.

In LTE, HARQ feedbacks (ACK/NACK) for downlink transmissions are conveyed using the Physical Uplink Control Channel (PUCCH) that is transmitted by the wireless device upon detection of a downlink transmission on the Physical Downlink Shared Channel (PDSCH) by the network node. For uplink transmissions, HARQ feedbacks (ACK/NACK) are conveyed by the Physical Hybrid-ARQ Indicator Channel (PHICH) channel that is transmitted by the network node 11 upon detection of an uplink transmission on the Physical Uplink Shared Channel (PUSCH) by the wireless device 12.

The handling of the HARQ timing differs between TDD (Time Division Duplex) and FDD (Frequency Division Duplex). In FDD, HARQ feedbacks for a certain transport block are expected to be received four subframes after the transmission of a transport block. In TDD, given the different amount of UL/DL occasions within the radio frame, HARQ feedbacks for a certain transport block are supposed to be received at the subframe n+k, where n is the subframe of the corresponding transport block transmission and k>=4 is such that n+k is an uplink or downlink subframe depending on whether a given HARQ feedback has to be transmitted in uplink or downlink, respectively.

Besides ACK/NACK, the HARQ mechanism can also be affected by discontinuous transmission (DTX) events. DTX relate to events in which the network node was expecting some transmission from the wireless device (or vice versa), e.g. data transmission, HARQ feedbacks, on a given TI (Transmission Time Interval), but no signal was detected over the air. Different reasons might trigger DTX events.

For instance, for data transfer over a Downlink Shared Channel (DL-SCH), DTX in the HARQ feedback from the UE can be due to the fact that either the wireless device missed a detection of a DL assignment (e.g. on Physical Downlink Control Channel (PDCCH)) or data was received but the network node could not detect the HARQ feedback (e.g. on PUCCH). Since the network node is not aware of the actual reason of DTX, it assumes a failed reception, leading to a retransmission of the transport block, also in cases when wireless device in fact could decode that packet but the subsequent ACK was not received properly.

FIG. 2 is a state diagram illustrating various power states for a wireless device of FIG. 1 in a discontinuous reception mode (DRX). Each state uses an average power and involves an average latency for communication. In the diagram of FIG. 2, states further to the left involve a greater latency and states further up involve greater average power usage for the wireless device in question.

The states are used for DRX, which is a feature provided in LTE/E-UTRAN (Evolved UMTS (Universal Mobile Telecommunications System) Terrestrial Radio Access Network) for saving power in the wireless device, and thus reducing battery consumption. A DRX cycle consists of a receiving period of an on duration and an idle period of an off duration, with a combined period then being the on duration plus the off duration. No data can be received during the energy saving off duration, whereby the device is in a temporarily incommunicable state. If data is received in downlink during the on duration, the wireless device will stay awake and start an inactivity timer. As long as the inactivity timer has not expired, the wireless device is in a communicable state.

There are two main states shown in FIG. 2, an RRC_IDLE state 26 and an RRC_CONNECTED state 22. In DRX, the RRC_CONNECTED state 22 comprises three individual states: a long DRX state 25, optionally a short DRX state 24 and a continuous reception state 23. The short DRX state 24 is optionally supported by the wireless device in question. The continuous reception state 23 is above the other states 24, 25, 26 in the diagram of FIG. 2, thereby using more power. Hence the power saving states 24, 25, 26 use progressively less power on average than the continuous reception state 23.

When in one of the long and short DRX states 24-25, the wireless device does not constantly monitor the PDCCH (Physical Downlink Control Channel), but only during specific receiving periods. In these states 24-25, between the receiving periods the wireless device goes into power saving idle mode, being an off period, for part of the time, which decreases power consumption.

Hence, two DRX cycles can be set for each wireless device: a short DRX cycle for the short DRX state 24 and a long DRX cycle for the long DRX state 25. When the wireless device is in the continuous reception state 23, an inactivity timer is started after a downlink packet is received. When the inactivity timer expires, the wireless device switches to the long DRX state 25 unless short DRX is configured, in which case it first stays in the short DRX state 24 for a configurable amount of time. In the DRX states 24 and 25, the wireless device can only receive packets during the on duration.

From the RRC_IDLE state 26, a random access procedure is required to get the wireless device back to the RRC_CONNECTED state 22 in general, and the continuous reception state 23 in particular.

There are a number of power state parameters that can be configured in the DRX state, such as on duration, the inactivity timer, the short DRX cycle timer, the long DRX cycle timer, the duration of the short DRX cycle, the duration of the long DRX cycle, retransmission timer, start offset, etc. These power state parameters can be configured for each wireless device separately and thus at least partly define when the wireless device is to be in an continuous reception state 23 or one of the power saving states 24, 25, 26. The retransmission timer parameter specifies the maximum number of consecutive PDCCH subframes the wireless device should remain active to be ready to receive an incoming retransmission after the first available retransmission time. The start offset parameter is an offset for each wireless device so that, in the time domain, not all wireless devices start receiving at the same time.

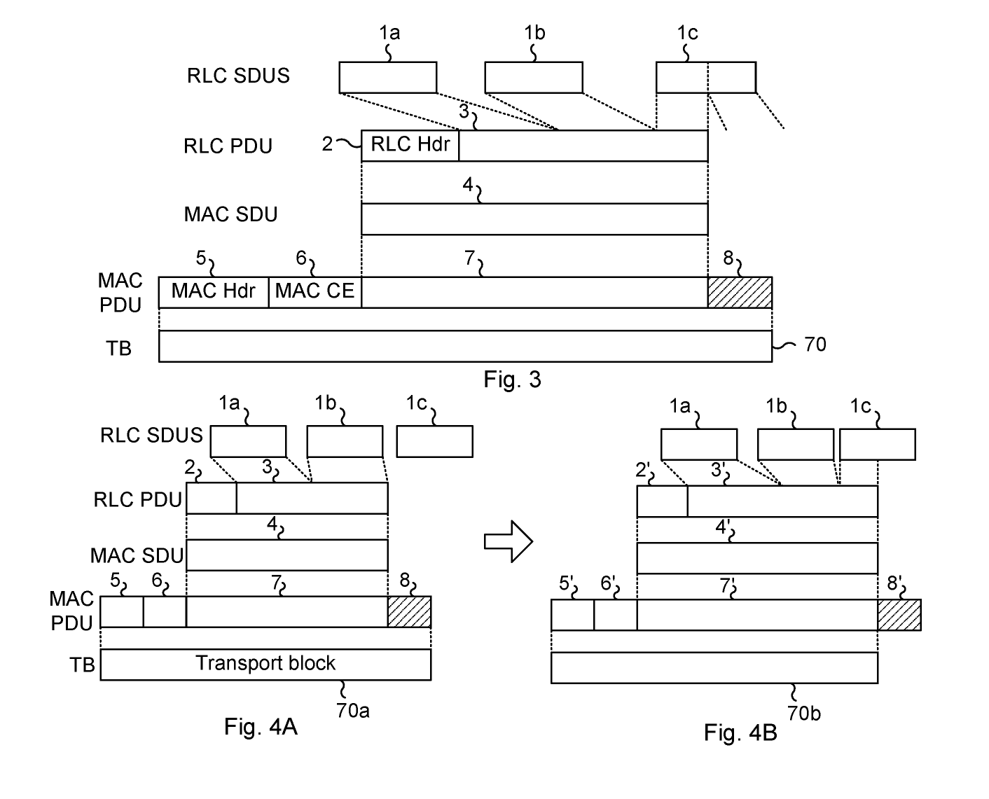

FIG. 3 is a schematic diagram illustrating the interworking of RLC (Radio Link Control) and MAC (Media Access) layers for downlink transmissions. Time flows from left to right.

In here a Service Data Unit (SDU) is data received from a higher layer. A Packet Data Unit (PDU) is data provided to a lower layer. For any layer, an SDU can be considered to form the payload part of one or more PDUs. A PDU for a higher layer is consequently an SDU for a lower layer. For instance, the RLC PDU is the MAC SDU.

Looking now to FIG. 3, the RLC layer receives packets 1a-c from higher layers. For instance, the packets 1a-c can be PDCP (Packet Data Convergence Protocol) PDUs.

The RLC layer is in charge of segmenting and concatenating received RLC SDUs 1a-c together with an RLC header 2 into an RLC PDU, and deliver to the MAC layer. The degree of segmentation/concatenation and hence the size of the RLC PDUs depends on scheduler decisions that take into account the type of traffic and channel conditions. In this example, all of the first RLC SDU 1a and the second SDU 1b, together with a subset of the third RLC SDU 1c are concatenated to the payload 3 of one RLC PDU.

For the MAC layer, the RLC PDU is a MAC SDU 4 and forms a payload part 7 of a MAC PDU together with a MAC header 5, possibly with RLC PDU segments from the same or other logical channels, and optionally with MAC Control Elements (MAC CE) 6 and padding 8 to match the size of the Transport Block (TB) in a downlink signal 70. The transport block is then mapped to a certain HARQ (Hybrid Automatic Repeat Request) process and transmitted over the air.

FIGS. 4A-B are schematic diagrams illustrating the interworking of RLC (Radio Link Control) and MAC (Media Access) layers when a downlink reception fails according to one embodiment. As for FIG. 3, time flows from left to right.

Looking first to FIG. 4A, the situation is similar to that shown in FIG. 3. Here however, only two RLC SDUs 1a-b are available at the time that the RLC PDU is generated. At a later time, a third RLC SDU 1c will become available.

The transport block, in a first downlink signal 70a, however, fails to be received by the wireless device for which the first downlink signal 70a is intended.

FIG. 4B illustrates a resegmentation which occurs due to the failed reception by the wireless device. At this stage, more payload data has become available. In particular part of a third RLC SDU 1c is available in a downlink buffer from higher layers.

In the prior art, the failed reception would simply result in a resend of the original MAC PDU. Here, however, the state of the downlink buffer is utilised and the additional available downlink data in the buffer forms a new payload part 3′ of a new RLC PDU. The new RLC PDU comprises the payload of the original RLC PDU (of FIG. 4A), as well as the additional payload data available in the downlink buffer from the RLC SDUs. Particularly when DRX is employed, there can be significant delay between transmissions, whereby it is of great advantage to include more data from higher layers whenever possible.

The new RLC PDU is a new MAC SDU 4′ forming a new payload part 7′ of a new PDU, with a new MAC header 5′ and MAC CE 6′ as needed. A new padding 8′ is generated (or omitted if not needed), depending on the size of the new payload part 7′, the new MAC header 5′ and any new MAC CE 6′.

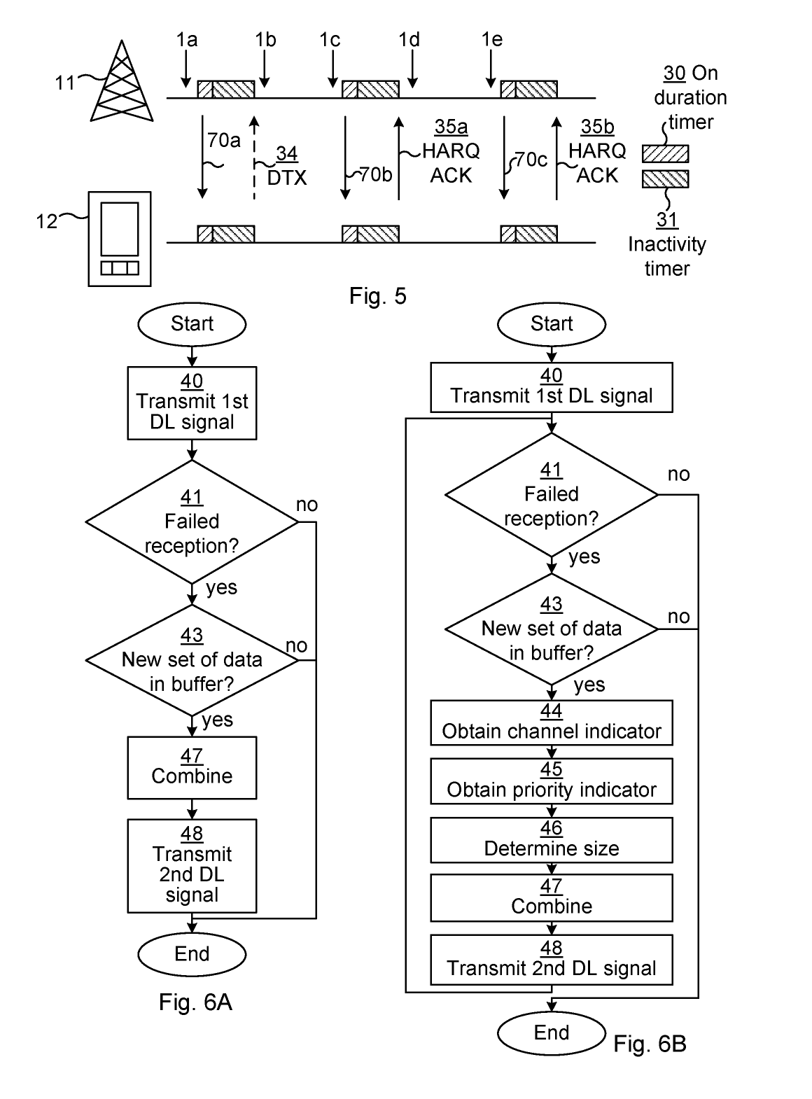

FIG. 5 is a schematic diagram illustrating signalling between the network node 11 and the wireless device 12 of FIG. 1 according to one embodiment. Time proceeds from left to right. This diagram illustrates resegmentation of RLC SDUs when reception fails at the wireless device. Also, for DRX, periods of the on duration timer 30 are shown, as well as inactivity timer periods 31.

The network node receives RLC SDUs 1a-e over time. Looking from left to right, first the network node receives a first RLC SDU 1a. As explained above, this results in a first downlink signal 70a in the form of a transport block to the wireless device 12. The first downlink signal 70a is transmitted in an on duration period 30 to allow the wireless device 12 to receive the downlink signal.

However, for some reason, the wireless device 12 fails to receive the first downlink signal 70a. This can e.g. be due to poor radio conditions, such as path loss, interference, etc. The failed reception can e.g. be detected by a DTX event 34 when the expected HARQ feedback is not received by the network node 11. The DTX event does not affect the wireless device, whereby the wireless device goes to sleep after the inactivity timer. In the prior art, this prevents a quick retransmission to compensate for the failed reception. In embodiments presented herein, however, this situation is remedied by including more data at the next transmission opportunity.

At the time for the next on duration, the network node 11 has also received a second RLC SDU 1b and a third RLC SDU 1c. Hence, according to embodiments herein, rather than resending the content of the first downlink signal 70a, a second downlink signal 70b is generated which not only contains the first RLC SDU 1a (which failed to be received by the wireless device 12), but also the new RLC SDUs 1b, 1c.

This time, the second downlink signal 70b is properly received by the wireless device 12 and the wireless device 12 sends a first HARQ ACK 35a to the network node 11. In this way, transmissions are synchronised with data from higher layers at this stage, effectively eliminating any delay in the transmission of the second RLC SDUs 1b and the third RLC SDU 1c which would occur in procedures of the prior art.

For the subsequent on duration, the network node 11 has received a fourth RLC SDU id and a fifth second RLC SDU 1b and a third RLC SDU 1c. Since the previous RLC SDUs 1a-c have been received correctly (in the second downlink signal 70b), as indicated by the first HARQ ACK 35a, these do not need to be retransmitted. Hence, the third downlink signal 70c is generated containing the fourth RLC SDU id and the fifth RLC SDU. The wireless device 12 receives the third downlink signal 70c correctly and sends a second HARQ ACK 35b.

Using this method of resegmentation, new packets of delay sensitive data, such as voice traffic or other real-time traffic, is transmitted sooner to the wireless device after a failed reception at the wireless device. Instead of only retransmitting the content of the transport block that failed to be received properly, a combination of old and new content is included in the retransmission, thereby reducing delay of new content SDUs.

FIGS. 6A-B are flow charts illustrating methods performed in the network node 11 of FIG. 1 for transmitting downlink signals. This method corresponds to the scenarios explained above with reference to FIGS. 4A-B and FIG. 5.

In a transmit is downlink (DL) signal step 40, a first downlink signal (e.g. 70a) is transmitted to a wireless device. The first downlink signal comprises a first set of payload data. For instance, the first downlink signal can correspond to a transport block.

In a conditional failed reception step 41, it is determined whether the first downlink signal fails to be received correctly in the wireless device. For instance, this can be determined by the occurrence of a DTX event.

Alternatively or additionally, the reception of a non-acknowledgement (NACK) from the wireless device can indicate a failed reception of the first downlink signal. If reception failed, the method proceeds to a conditional new set of data in buffer step 43. Otherwise, the method ends.

In the conditional new set of data in buffer step 43, it is determined whether there is a new set of payload data (e.g. a new data packet) is available in a downlink buffer, e.g. in the form of RLC SDUs. If this is the case, the method proceeds to a combine step 47. Otherwise, the method ends.

In a combine step 47, at least part of the first set of payload data is combined with at least part of the new set of payload data in a combined set of payload data. This can comprise segmenting the mentioned payload data in a radio link control, RLC, layer.

In a transmit 2^{nd} DL signal step 48, a second downlink signal is transmitted to the wireless device. The second downlink signal comprises the combined set of payload data. The second downlink signal can comprise a new data indicator (NDI), e.g. in the form of a toggle, indicating that the second downlink signal comprises new payload data. For instance, the second downlink signal can correspond to a transport block.

Using this method, additional flexibility is provided to the scheduler since the content of a transport block (MAC PDU) can be re-adjusted even though HARQ retransmissions are pending for that transport block. The re-adjustments are made with consideration to the status of the downlink buffers for new incoming packets, thereby reducing the delay and packet drops, which is particularly useful for delay sensitive services. Moreover, by bundling additional RLC SDU segments for a certain wireless device the network node saves scheduling entities per time unit compared with the regular HARQ retransmission scheme, where the same MAC PDU might be rescheduled multiple times until positive acknowledgment. Thereby, this solution increases system efficiency and thus capacity in these situations.

The solution is particularly useful for those scenarios in which retransmissions must for different reasons be postponed for some subframes e.g. as in the presence of measurement gap, or to avoid inter-cell interference, and DRX (as explained above). In such cases, the buffer status (as well as the channel conditions) might change significantly while the HARQ process is postponed.

FIG. 6B is a flow chart illustrating a method performed in the network node of FIG. 1. This method is similar to the method illustrated in FIG. 6A, and only new or modified steps, in relation to FIG. 6A, will be described.

In an optional obtain channel indicator step 44, a channel indicator is obtained. The channel indicator indicates channel conditions for transmission to the wireless device.

In an optional obtain priority indicator step 45, a priority indicator (e.g. a Quality of Service (QoS) Indicator) is obtained. The priority indicator indicates a priority for transmissions to the wireless device.

When priority indicator is available, this is used in the combine step 47 such that a higher priority indicator results in more of the new set of payload data being included in the combined set of data.

In an optional determine size step 46 a size for the combined set of payload data is determined based on the channel conditions indicated by the channel indicator. This can be done by determining the size of a transport block and thus working out the size which can be used for the combined set of payload data. Optionally, a channel deterioration margin is added to the channel indicator. Depending on the nature of the channel indicator, the channel deterioration margin can be positive or negative. For instance, if the channel indicator used is SINR (Signal to Interference and Noise Ratio), the channel deterioration margin is negative.

Since there can be a significant time difference between transmissions, channels conditions might be different when the network node schedules the second downlink signal. For instance if employed during DRX, an entire DRX cycle (e.g. 40 ms) elapses between transmissions. At the time of the second transmission, as explained above, the network node may decide to increase the size of the transport block to be able to fit in new RLC SDU segments. As known in the art per se, the wireless device measures channel quality on occasion and signals the channel quality using a Channel Quality Indicator (CQI) to the network node. However, depending of CQI periodicity, the network node might lack up-to-date information about downlink channel quality. For this reason, in order to avoid a too aggressive RLC SDU bundling to which would result in even further reception problems, the channel deterioration margin can be added to the channel indicator. This is a conservative approach that reduces the risk of being too optimistic in the channel quality, which could result in more losses.

For instance, during link adaptation, the new transport block can be built considering SINR=SINR_old−X, where SINR_old is the SINR estimated at reception of last CQI, while X [db] is a the deterioration margin being a configurable (or dynamically calculated) offset to compensate for possible channel conditions changes during sleep period. The value of X might be reflected for instance into the selection of a more conservative MCS (Modulation and Coding Scheme) and larger PRB (Physical Resource Block) allocation.

However, in case the presence of a NACK is used to detect failure in the conditional failed reception step 41, the network node may toggle the NDI. This results in the wireless device discarding the unsuccessfully decoded replica of the first downlink signal, preventing the use of soft combining in the wireless device, which gives a theoretical gain of 3 dB. Thus, in order to compensate the loss of the soft combining gain, an additional channel quality adaptation (e.g 3 dB) can be taken into account to make the link adaptation more robust in case of NACK event, i.e. a larger deterioration margin can be applied when NACK is used to detect reception failure.

The new set of payload data can be combined with the older payload data as long as the link adaption is able to allocate a size of the transport block which is sufficient to hold all the payload data. This size depends on the size of the individual packets. If packet size is large, this may put additional strain on the PRB resources of the system. Since delay sensitive services benefit the most from this method, differentiation of data can be performed such that only delay sensitive data is included in the second downlink signal. Such differentiation can e.g. be done based on Quality of Service (QoS) classes. Alternatively or additionally, the selection of the bearers that can be bundled to can be made on basis of ARP (Allocation and Retention Priority) of the QoS. Alternatively or additionally, only traffic to some specific wireless devices are prioritised, e.g. business or enterprise profile users. Using this consideration, excessive PRB resource consumption can be avoided.

Optionally, the method is repeated. In such a case, in the combine step 47, the first set of payload data can be discarded and omitted from the combined set of payload data when the first set of data has been transmitted a predefined maximum number of times. For instance, one option is to define a counter in the network node that counts how many retransmission of a certain HARQ process can be used to trigger the buffer-aware retransmissions scheme. If the counter exceeds the predefined maximum, for a certain MAC PDU containing the RLC segment A, the RLC layer stops bundling segment A with newer RLC segments and discards it. Additionally or alternatively, also the packet delay budget can be taken into account, i.e. if the packet delay budget of the RLC segment A is above a certain threshold, which is based on the requirement of a certain QoS, the RLC layer stops bundling packet A with newer RLC segments and discards it.

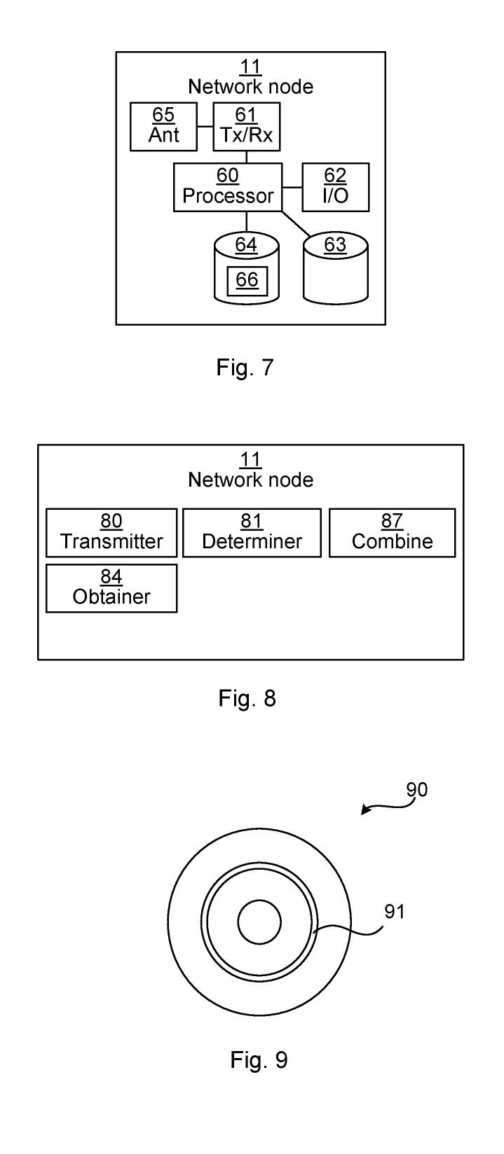

FIG. 7 is a schematic diagram showing some components of the network node 11 of FIG. 1. A processor 60 is provided using any combination of one or more of a suitable central processing unit (CPU), multiprocessor, microcontroller, digital signal processor (DSP), application specific integrated circuit etc., capable of executing software instructions 66 stored in a memory 64, which can thus be a computer program product. The processor 60 can be configured to execute the method described with reference to FIGS. 6A-B above.

The memory 64 can be any combination of read and write memory (RAM) and read only memory (ROM). The memory 64 also comprises persistent storage, which, for example, can be any single one or combination of magnetic memory, optical memory, solid state memory or even remotely mounted memory.

A data memory 63 is also provided for reading and/or storing data during execution of software instructions in the processor 60. The data memory 63 can be any combination of read and write memory (RAM) and read only memory (ROM).

The network node 11 further comprises an I/O interface 62 for communicating with other external entities. Optionally, the I/O interface 62 also includes a user interface.

The network node 11 also comprises one or more transceivers 61, comprising analogue and digital components, and a suitable number of antennas 65 for wireless communication with wireless devices.

Other components of the network node 11 are omitted in order not to obscure the concepts presented herein.

FIG. 8 is a schematic diagram showing functional modules of the network node 11 of FIGS. 1 and 7. The modules can be implemented using software instructions such as a computer program executing in the network node 11 and/or using hardware, such as application specific integrated circuits, field programmable gate arrays, discrete logical components, etc. The modules correspond to the steps in the methods illustrated in FIGS. 6A-B.

A transmitter 80 is configured to perform steps 40 and 48. A determiner 81 is configured to perform steps 41, 43 and 46. A combiner 87 is configured to perform step 47. An obtainer is configured to perform steps 44 and 45. FIG. 9 shows one example of a computer program product comprising computer readable means. On this computer readable means a computer program 91 can be stored, which computer program can cause a processor to execute a method according to embodiments described herein. In this example, the computer program product is an optical disc, such as a CD (compact disc) or a DVD (digital versatile disc) or a Blu-Ray disc. As explained above, the computer program product could also be embodied in a memory of a device, such as the computer program product 64 of FIG. 7. While the computer program 91 is here schematically shown as a track on the depicted optical disk, the computer program can be stored in any way which is suitable for the computer program product, such as a removable solid state memory, e.g. a Universal Serial Bus (USB) drive.

The invention has mainly been described above with reference to a few embodiments. However, as is readily appreciated by a person skilled in the art, other embodiments than the ones disclosed above are equally possible within the scope of the invention, as defined by the appended patent claims.

1. A method for transmitting downlink signals, the method being performed in a network node of a cellular network and comprising the steps of:
transmitting a first downlink signal to a wireless device, the first downlink signal comprising a first set of payload data;
determining a failed reception of the first downlink signal;
determining that a new set of payload data is available in a downlink buffer;
combining at least part of the first set of payload data with at least part of the new set of payload data in a combined set of payload data; and
transmitting a second downlink signal to the wireless device, the second downlink signal comprising the combined set of payload data.

2. The method according to claim 1, further comprising the steps of:
obtaining a channel indicator indicating channel conditions for transmission to the wireless device; and
determining a size for the combined set of payload data based on the channel conditions.

3. The method according to claim 2, wherein the step of determining a size for the combined set of payload data comprises adding a channel deterioration margin to the channel indicator.

4. The method according to claim 1, wherein the step of determining a failed reception comprises determining occurrence of a discontinuous transmission, DTX.

5. The method according to claim 1, wherein the step of determining a failed reception comprises receiving a non-acknowledgement, indicating a failed reception of the first downlink signal.

6. The method according to claim 1, further comprising the step of:
obtaining a priority indicator indicating a priority for transmissions to the wireless device; and
wherein in the step of combining, a higher priority indicator results in more of the new set of payload data being included in the combined set of data.

7. The method according to claim 1, wherein the step of combining comprises segmenting the mentioned payload data in a radio link control, RLC, layer.

8. The method according to claim 1, wherein the second downlink signal comprises a new data indicator, NDI, indicating that the second downlink signal comprises new payload data.

9. The method according to claim 1, wherein the method is repeated and wherein, in the step of combining, the first set of payload data is discarded and is omitted from the combined set of payload data when the first set of data has been transmitted a predefined maximum number of times.

10. A network node for use in a cellular network for transmitting downlink signals, the network node comprising:
a processor; and
a memory storing instructions that, when executed by the processor, cause the network node to:
transmit a first downlink signal to a wireless device, the first downlink signal comprising a first set of payload data;
determine a failed reception of the first downlink signal;
determine that a new set of payload data is available in a downlink buffer;
combine at least part of the first set of payload data with at least part of the new set of payload data in a combined set of payload data; and
transmit a second downlink signal to the wireless device, the second downlink signal comprising the combined set of payload data.

11. The network node according to claim 10, further comprising instructions that, when executed by the processor, cause the network node to:
obtain a channel indicator indicating channel conditions for transmission to the wireless device; and
determine a size for the combined set of payload data based on the channel conditions.

12. The network node according to claim 11, wherein the instructions to determine a size for the combined set of payload data comprise instructions that, when executed by the processor, cause the network node to add a channel deterioration margin to the channel indicator.

13. The network node according to claim 10, wherein the instructions to determine a failed reception comprise instructions that, when executed by the processor, cause the network node to determine occurrence of a discontinuous transmission, DTX.

14. The network node according to claim 10, wherein the instructions to determine a failed reception comprise instructions that, when executed by the processor, cause the network node to receive a non-acknowledgement, indicating a failed reception of the first downlink signal.

15. The network node according to claim 10, further comprising instructions that, when executed by the processor, cause the network node to obtain a priority indicator indicating a priority for transmissions to the wireless device; and wherein the instructions to combine comprise instructions that, when executed by the processor, cause the network node to include more of the new set of payload data when the priority indicator is higher compared to when the priority indicator is lower.

16. The network node according to claim 10, wherein the instructions to combine comprise instructions that, when executed by the processor, cause the network node to segment the mentioned payload data in a radio link control, RLC, layer.

17. The network node according to claim 10, wherein the second downlink signal comprises a new data indicator, NDI, indicating that the second downlink signal comprises new payload data.

18. The network node according to claim 10, wherein the instructions are repeated and wherein, the instructions to combine comprise instructions that, when executed by the processor, cause the network node to discard the first set of payload data and omit the first set of payload data from the combined set of payload data when the first set of data has been transmitted a predefined maximum number of times.

19. A network node comprising:
means for transmitting a first downlink signal to a wireless device, the first downlink signal comprising a first set of payload data;
means for determining a failed reception of the first downlink signal;
means for determining that a new set of payload data is available in a downlink buffer;
means for combining at least part of the first set of payload data with at least part of the new set of payload data in a combined set of payload data; and
means for transmitting a second downlink signal to the wireless device, the second downlink signal comprising the combined set of payload data.

20. A computer program for transmitting downlink signals, the computer program comprising computer program code which, when run on a network node of a cellular network causes the network node to:
transmit a first downlink signal to a wireless device, the first downlink signal comprising a first set of payload data;
determine a failed reception of the first downlink signal;
determine that a new set of payload data is available in a downlink buffer;
combine at least part of the first set of payload data with at least part of the new set of payload data in a combined set of payload data; and
transmit a second downlink signal to the wireless device, the second downlink signal comprising the combined set of payload data.

21. (canceled)
